(19) United States
(12) Patent Application Publication
(10) Pub. No.: US 2007/0166209 A1
(43) Pub. Date: Jul. 19, 2007

(54) Discharge tube

(76) Inventor: Stefan Zimmerman, Siegburg (DE)

Correspondence Address: SUGHRUE MION, PLLC, 2100 PENNSYLVANIA AVENUE, N.W., SUITE 800, WASHINGTON, DC, 20037, US

(21) Appl. No.: 10/552,683

(22) PCT Filed: Oct. 21, 2004
(86) PCT No.: PCT/EP04/03762

§ 371 Date: Jun. 21, 2006

(30) Foreign Application Priority Data
Apr. 10, 2003 (DE) 103 16 378.6

(51) Int. Cl. B01J 19/08

(52) U.S. Cl. 422/186.07

(57) ABSTRACT

The invention relates to a discharge tube comprising an isolator tube with an internal surface and an external surface, an internal electrode consisting of a flexible flat material, which rests on the internal surface, an external electrode, which rests on the external surface, a spring element comprising at least one metal wire, which rests on at least part of the length of the internal electrode, causing the latter to impinge on the internal surface. The discharge tube has a low noise emission during operation and the components of said tube can be easily dismantled.

The invention relates to a discharge tube, more particularly for the ionisation of air, oxygen or other gases, and for producing ozone from air or oxygen.

The ionisation of air oxygen results in the air being cleaned and sterilised. For sterilisation purposes, for example, it is common practice to use air ionisation generators according to CH 666 372 A5. Said generators comprise an insulator tube made of glass for example in the interior of which there is arranged a sleeve-shaped inner electrode so as to rest against the inner wall of the insulator tube. An outer electrode is provided and arranged so as to contact the outer wall. Between the two electrodes there is generated a high voltage which causes a corona discharge between the two electrodes. The corona discharge leads to fission and an ionisation of the oxygen molecules of the air. As a result of the oxygen molecules (O₂) there are produced highly reactive oxygen atoms which act as oxidisation means and, immediately after having been produced, oxidise oxidisable substances and thus damage the cell structure of micro-organisms. These include viruses, mould pores, bacteria and odour molecules and contaminants.

The ionisation of oxygen molecules leads to oxygen ions which also have the effect of cleaning the air. They bond further oxygen molecules and thus form so-called oxygen clusters. The oxygen ions bind floating dust particles in the air, so that these sink as a result of their increasing weight, thus effecting the air to be cleaned. Furthermore, because of their increasing size, the dust particles can be filtered more easily.

When the voltage applied is increased, the percentage of atomic oxygen which is not oxidised with substances, but forms ozone (O₃) is increased, so that, in principle, such discharge tubes can also be used for the production of ozone. However, if such tubes are used for air cleaning purposes, it is necessary, in some cases, to monitor the quantity of ozone produced or to keep it as small as possible by applying a lower voltage.

Conventional discharge tubes used for ionisation comprise an outer electrode in the form of a woven wire fabric or braided wire fabric which is hose-shaped. It can be slid over the insulator tube in the process of which it is expanded, resting with pretension on the outer face of the insulator tube.

The inner electrodes consist of metal grid or punched plate, both usually made of aluminium. The metal grid or punched plate is formed into a cylindrical member which is slid into the insulator tube. In the untensioned condition, the inner electrode has an outer diameter which is slightly greater than the inner diameter of the insulator tube, so that the inner electrode rests with pretension against the inner face of the insulator tube. The pretension is generated by the internal spring force of the inner electrode. There are also prior art insulator tubes whose inside is provided with a “bright silver coating” which constitutes the inner electrode.

For connecting the inner electrode to a voltage source, there are provided conductors which are riveted or soldered to the inner electrode. Alternatively, there are used contact elements which are pressed with pretension against the inner electrode. Such point-like electrical connections are disadvantageous in that at the contact point between the connected conductor and the inner electrode, the inner electrode is subjected to high point-like wear. The point-like transfer of voltage from the inner electrode causes a very high brush discharge at this point, which can lead to a fracture of the insulator tube.

Furthermore, conventional insulator tubes comprise large dimensional tolerances so that, if inner electrodes in the form of metal grids or punched plate are used, there occur gaps along the length of the insulator tube. Therefore, in the course of the corona discharge, noise develops due to the vibrations of the inner electrode. In this case, too, the uneven contact of the inner electrode results in a concentrated or irreglar discharge which can damage the insulator tube.

From DE 299 11 754 U1 there is known a discharge tube wherein there is used a connecting conductor in the form of a bristle contact. Along the entire length of the inner electrode, the connecting conductor comprises radially extending bristles which are in contact with the inner electrode. To ensure a perfect contact between the bristles and the inner electrode, the bristles rest with pretension against the inner electrode. When fitting the bristle contact, the bristles are slightly bent in the direction opposed to the introducing direction of the bristle contact and, because of their elasticity, they closely rest against the inner electrode. However, when recycling said discharge tubes, it requires a great deal of effort to remove such bristle contacts because when pulling out the bristle contacts in the direction opposed to the introducing direction, the bristles straighten and get caught in the inner electrodes, especially if metal grids or punched plates are used. As a result, high radial forces are generated by the bristles and applied to the inner face of the insulator tube and to the inner electrode, which radial forces can lead to damage to or the destruction of the insulator tube or the inner electrode.

It is the object of the present invention to provide a discharge tube which, when in operation, develops a small amount of noise only, ensures an even discharge and whose components are easy to fit or remove.

In accordance with the invention, the objective is achieved by a discharge tube comprising
an insulator tube having an inner face and an outer face,
an inner electrode which consists of a flexible laminar material and which is in contact with the inner face,
an outer electrode which is in contact with the outer face,
a spring element having at least one piece of metal wire which, at least along part of the length of the inner electrode, is in contact therewith and loads same towards the inner face.

The flexible laminar material from which the inner electrode is produced, when being deformed, builds up either no internal stress or only a very small amount of internal stress. In consequence, the inner electrode cannot be held in a planar way against the inner face as a result of internal stress. The flexible laminar material comprises a high degree of flexibility and is equally bendable and deformable in all directions, so that even the smallest dimensional tolerances of the insulator tube can be compensated for. The spring element ensures that the inner electrode is pressed in a planar way against the inner face of the insulator tube, with dimensional tolerances being compensated for. Because the inner electrode rests in a uniform way against the innsulator tube, it is possible to achieve a uniform discharge rate and very little vibration. Furthermore, it is ensured that the spring element can easily be removed because the metal wire rests along its length against the inner electrode and thus cannot get caught on or inside the inner electrode.

Furthermore, the metal wire ensures that a uniform electric voltage is applied to the inner electrode along the length of the metal wire and that the internal resistance of the inner electrode does not lead to a decrease in voltage in the longitudinal direction of the inner electrode. The metal wire can extend along the entire length of the inner electrode, so that just by providing the metal wire it is ensured that the inner electrode rests against the inner face of the insulator tube in a planar way along the entire length of same.

The spring element is preferably provided in the form of a helical spring whose outer diameter in the untensioned condition, i.e. in the unmounted condition, is greater than the inner diameter of the inner electrode when it rests against the inner face of the insulator tube. The helical spring constitutes a component which is easy to produce and cost-effective and which generates the electrical contact with the inner electrode and presses the latter against the inner face of the insulator tube. Furthermore, the spring element in the form of a helical spring can easily be fitted in the insulator tube in that it is introduced into the insulator tube in a rotatingly driven condition. As a result, the helical spring is drawn into the insulator tube. In the same way, it is easy to remove the spring element, as a result of which the inner electrode can be easily removed.

In order to achieve a longer service life, the spring element is produced from highgrade steel. The inner electrode can also be produced from high-grade steel. As a result, the service life, if compared to discharge tubes with inner electrodes consisting of aluminium, is clearly improved.

Furthermore, it is possible to provide a contact element which at least along the greatest part of the length of the outer electrodes, preferably along the entire length of the outer electrode, is in contact therewith. In this way, it is ensured that along the length of the electrical contact between the contact element and the outer electrode, there prevails a uniform electrical voltage at the outer electrode and that the internal resistance of the outer electrode does not lead to a decrease in voltage in the longitudinal direction. It is thus possible to achieve uniformly distributed discharge rates along the length.

In accordance with the invention, the objective is achieved by providing a discharge tube comprising
an insulator tube with an inner face and an outer face,
an inner electrode which is in contact with the inner face,
an outer electrode which is in contact with the outer face,
a contact element which, at least along the greatest part of the length of the outer electrode, is in electrical contact therewith.

In a preferred embodiment, the contact element is in electrical contact with the outer electrode along the entire length of same.

The contact element can be connected to the outer element in a material-locking way, i.e. it can be soldered to the outer electrode.

Alternatively, the outer electrode can be arranged at a radial distance from the insulator tube and form guiding means in which the contact element is received. The guiding means can be provided in the form of a channel and the contact element can be provided in the form of a piece of wire, with the contact element being slid into the guiding means. The outer electrode can be produced in the form of a radially expandable woven wire fabric or braided wire fabric in the shape of a hose, with these being connected, e.g. soldered to one another along a connecting line in the longitudinal direction of the outer electrode, so that there is formed a first hose portion which accommodates the insulator tube and a second hose portion which extends parallel to the first hose portion and accommodates the contact element.

The inner electrode is preferably produced from a woven wire fabric comprising a fine to finest mesh width, or from a grid. However, the element can also be produced from a thin plate material or foil and comprise apertures like a punched plate.

According to a preferred embodiment it is proposed that the inner face and the outer face of the insulator tube are cylindrical in shape and arranged coaxially relative to a longitudinal axis. The inner electrode and the outer electrode are cylindrical and arranged coaxially relative to the longitudinal axis.

The outer electrode is preferably produced from a radially expandable woven wire fabric or a braided wire fabric provided in the shape of a hose. The outer electrode, while being slightly radially expanded, can easily be slid on to the insulator tube, so that the outer electrode is arranged on the insulator tube with pretension.

The outer electrode is again preferably produced from high-grade steel.

The insulator tube can also be produced from glass, for example lime soda glass or borosilicate glass. Lime soda glass is advantageous in that the insulator tube can be produced cost-effectively and, in addition, it comprises high strength values. Borosilicate glass, on the other hand, has better electrical breakdown values, but fractures more easily.

The insulator tube, at one longitudinal end, preferably comprises a base which is produced so as to be integral with the insulator tube and closes same.

Furthermore, the insulator tube, at a second longitudinal end, comprises an aperture through which the inner electrode and the spring element can be slid into the insulator tube.

To avoid any damage at the aperture of the insulator tube, more particularly if distortion-resistant inner electrodes are used which require a high pressure force, the insulator tube is designed so as to be tapered along part of the length towards the aperture.

Preferred embodiments will be explained below in greater detail with reference to the drawings wherein

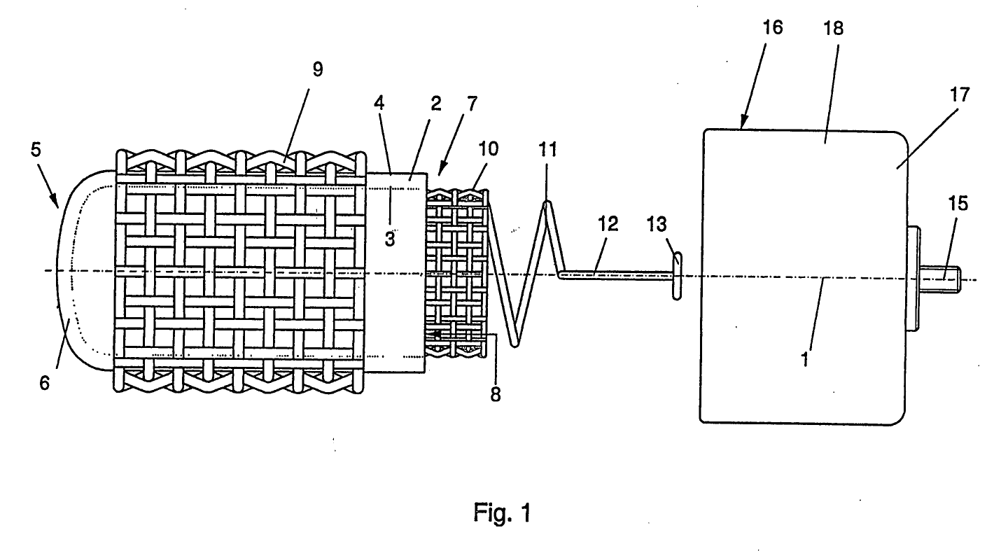

FIG. 1 is an exploded view of a first embodiment of a discharge tube which is in accordance with the invention.

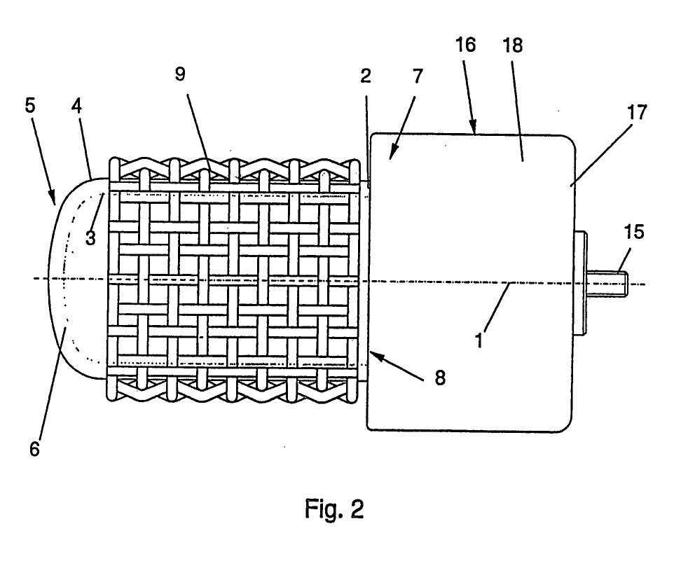

FIG. 2 is a side view of the discharge tube according to FIG. 1.

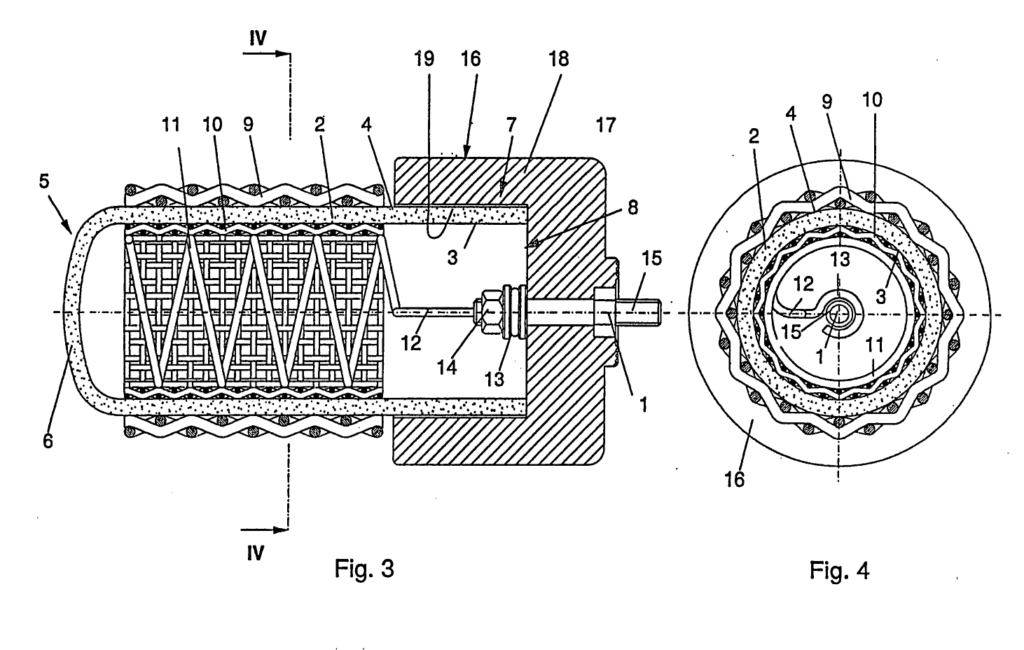

FIG. 3 is a longitudinal section through a discharge tube according to FIG. 1.

FIG. 4 is a cross-section along the sectional line IV-IV according to FIG. 3.

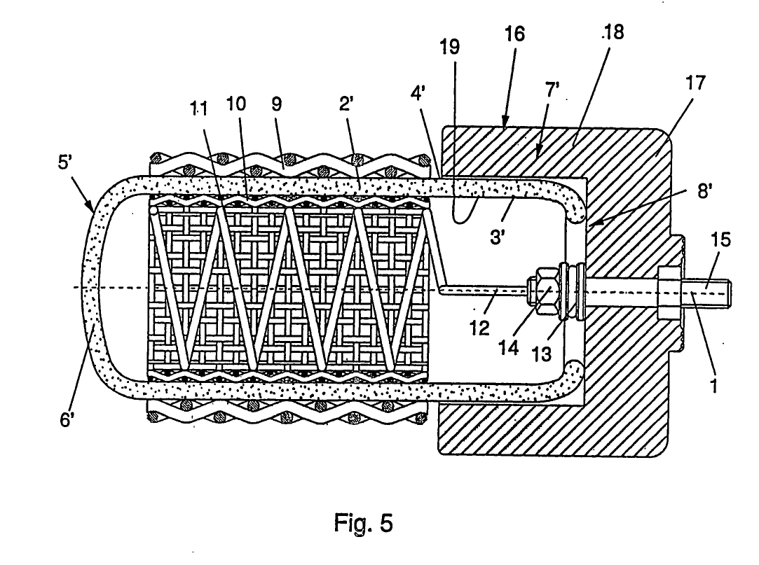

FIG. 5 is a longitudinal section through a discharge tube in accordance with the invention, whose insulator tube is tapered towards the aperture.

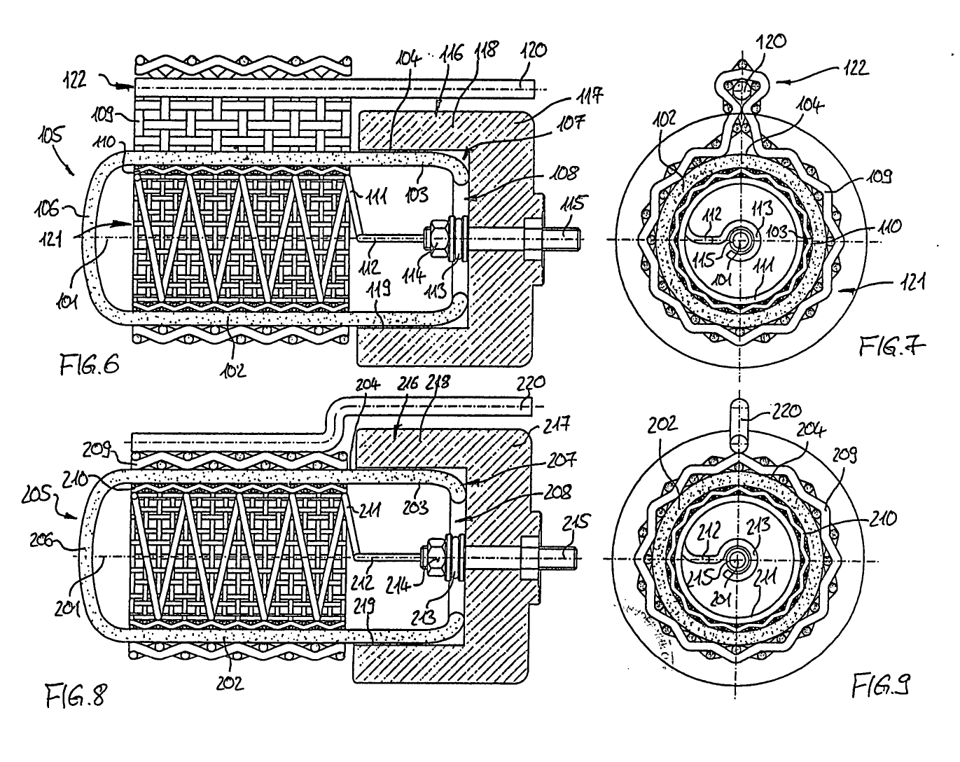

FIG. 6 is a longitudinal section through a second embodiment of an inventive discharge tube.

FIG. 7 is a cross-section along the sectional line VII-VII according to FIG. 6.

FIG. 8 is a longitudinal section through a third embodiment of an inventive discharge tube, and

FIG. 9 is a cross-section along the sectional line IX-IX according to FIG. 8.

FIGS. 1 to 4 show various illustrations of a first embodiment of a discharge tube which is in accordance with the invention. For the sake of clarity, the discharge tube and its components are not shown true to scale. FIGS. 1 to 4 will be described jointly below.

The discharge tube extends along a longitudinal axis 1 and, coaxially thereto, comprises an insulator tube 2 which is preferably made of glass. The insulator tube 2 comprises a cylindrical inner face 2 arranged coaxially relative to the longitudinal axis 1 and a cylindrical outer face 4 arranged coaxially relative to the longitudinal axis 1. At its first longitudinal end 5, the insulator tube 2 comprises a base 6 which closes the insulator tube 2 at its first longitudinal end 5. The base 6 is formed so as to be integral with the insulator tube 2. At its second longitudinal end 7 remote from the first longitudinal end 5, the insulator tube comprises an aperture 8.

Around the insulator tube 2, there is arranged an outer electrode 9 so as to extend coaxially relative to the longitudinal axis 1. The outer electrode 9 extends along the greatest part of the length of the insulator tube 2 and rests with pretension against its outer face 4. The outer electrode 9 is produced from an expandable woven wire material or braided wire material in the form of a hose. The outer electrode 9 can thus be slipped over the insulator tube 2, with the outer electrode 9 being slightly extended, so that it is firmly held on the insulator tube 2. To be able to transmit current and to provide a connection with a voltage source, it is possible to use a spring clip which, by means of a spring force, is pressed against the outer electrode 9.

An inner electrode 10 is slid into the insulator tube 2, starting from the aperture 8. The inner electrode 10 lengthwise extends approximately along the same distance as the outer electrode 9 and is cylindrical in shape and arranged coaxially relative to the longitudinal axis 1. The inner electrode is produced from a woven wire fabric which is extremely flexible, so that, with the given inner diameter of the insulator tube 2, it comprises only a minimum amount of internal stability. As a result, dimensional tolerances of the insulator tube 2 cannot be compensated for. Furthermore, in the case of a corona discharge, the inner electrode 10 is made to vibrate, so that it hits the inner face 3 of the insulator tube 2.

This is the reason why a spring element in the form of a spiral helical spring is arranged coaxially relative to the longitudinal axis 1, with the windings of said spring element extending along the length of the inner electrode 10 and loading the inner electrode 10 with pretension against the inner face 3 of the insulator tube 2. In the untensioned condition, i.e. in the unmounted condition of the helical spring 11, the windings of the latter comprise an outer diameter which is greater than the inner diameter of the inner electrode 10 in the mounted condition. This means that, in the course of the helical spring 11 being mounted, it has to be slightly radially compressed in order to generate a pretension.

At its end facing the aperture 8 of the insulator tube 2, the helical spring 11 comprises an attaching portion 12 with an eye 13. The eye 13 is connected by means of a nut 14 to an electric connector 15. The electric connector 15 is guided through a cap 16, so that it can be connected to a voltage source. The cap 16 comprises a base portion 17 which extends transversely to the longitudinal axis 1 and which closes the aperture 8 of the insulator tube 2. Edge portions 18 which extend coaxially relative to the longitudinal axis 1 form a recess 19 into which the second longitudinal end 7 of the insulator tube 2 is inserted. In a region of contact between the edge portion 18 and the insulator tube 2, the latter can be connected to one another, e.g. by means of a glued connection.

As a result of the line contact between the helical spring 11 and the inner electrode 10, the helical spring 11 can be fitted simply by being turned into the insulator tube 2. During the fitting process, the helical spring 11 is drawn into the insulator tube 2 in the course of a rotating movement. The discharge tube can thus be easily removed, so that the individual components can be recycled. Due to the line contact and the contact of the helical spring 11 along the entire length of the inner electrode 10, it is ensured that the inner electrode 10, along its entire length, rests against the inner face 3 of the insulator tube 2, and due to a high degree of flexibility of the woven wire fabric of the inner electrode 10, dimensional tolerances of the insulator tube 2 can be compensated for. Because no gaps occur between the inner electrode 10 and the inner face 3, it is not possible for vibrations and a concentrated brush discharge to occur at the inner electrode 10, which would lead to the development of noise and damage to the insulator tube 2.

FIG. 5 shows an inventive discharge tube, wherein the insulator tube 2′ is tapered towards the aperture 8′. Any components and characteristics corresponding to those of FIGS. 2 to 4 have been given the same reference numbers and are described in said Figures.

With the exception of the insulator tube 2′, the discharge tube according to FIG. 5 corresponds to the discharge tube according to FIGS. 1 to 4. The insulator tube 2′ is tapered towards the aperture 8′, which considerably increases the strength of the insulator tube 2′ in the region of the aperture 8′, so that the risk of the insulator tube 2′ fracturing is reduced. More particularly, if use is made of a spiral spring 11 with an increased spring force, fractures, more particularly during the mounting and dismantling operations, are prevented.

FIGS. 6 and 7 show various illustrations of a second embodiment of an inventive discharge tube. In respect of the inner electrode 110 and the spring element in the form of a spiral helical spring 111, the second embodiment corresponds to the first embodiment. Furthermore, the outer electrode 109, too, in principle, is designed like the one shown in the first embodiment. However, the outer electrode 109 is provided in the shape of a hose with two hose portions extending parallel relative to one another. The outer electrode is connected in a material-locking way along a connecting axis extending parallel to the longitudinal axis 101 of the insulator tube 102 in such a way that two hose portions 121, 122 are formed. The outer electrode 109 is slid over the insulator tube 102 by means of a first hose portion 121 and a contact element 120 in the form of a wire is slid into a second hose portion 122 which forms a guide in the form of a channel, with the contact element 122 serving to connect the outer electrode 109 to a voltage source. There is thus ensured an electric contact between the contact element 122 and the outer electrode 109 along the entire length of the outer electrode 109. The internal resistance of the outer electrode 109 does not lead to a reduction in voltage in the longitudinal direction of same. More particularly, as the inner electrode 110, too, is in electric contact with a voltage source via the spring element in the form of a helical spring 111 along its entire length, a uniform discharge rate is ensured along the entire length of the electrodes 109, 110.

FIGS. 8 and 9 show different illustrations of a third embodiment of an inventive discharge tube. Both the inner electrode 210 and the outer electrode 209 correspond to those of the first embodiment. However, in contrast to the first embodiment, there is provided a contact element 220 in the form of a piece of wire which extends parallel to the longitudinal axis 201 of the insulator tube 202 and is preferably connected in a material-locking way to the outer electrode 209. In a preferred embodiment, the contact element 220 is soldered to the outer electrode 209. This results in the same advantages as in the case of the second embodiment of the discharge tube.

### LIST OF REFERENCE NUMBERS

1 longitudinal axis
2, 2′ insulator tube
3 inner face
4 outer face
5, 5′ first longitudinal end
6, 6′ base
7, 7′ second longitudinal end
8, 8′ aperture
9 outer electrode
10 inner electrode
11 helical spring
12 attaching portion
13 eye
14 nut
15 electrical connector
16 cap
17 base portion
18 edge portion
19 recess
101 longitudinal axis
102 insulator tube
103 inner face
104 outer face
195 first longitudinal end
106 base
107 second longitudinal end
108 aperture
109 outer electrode
110 inner electrode
111 helical spring
112 attaching portion
113 eye
114 nut
115 electrical connector
116 cap
117 base portion
118 edge portion
119 recess
120 contact element
121 first hose portion
122 second hose portion
201 longitudinal axis
202 insulator tube
203 inner face
204 outer face
205 first longitudinal end
206 base
207 second longitudinal end
208 aperture
209 outer electrode
210 inner electrode
211 helical spring
212 attaching portion
213 eye
214 nut
215 electrical portion
216 cap
217 base portion
218 edge portion
219 recess
220 contact element

1. A discharge tube comprising:
an insulator tube with an inner face and an outer face,
an inner electrode which is in contact with the inner face,
an outer electrode which is in contact with the outer face,
a contact element which, at least along the greatest part of the length of the outer electrode, is in electrical contact therewith.

2. A discharge tube according to claim 1,
wherein the contact element, along the entire length of the outer electrode, is in electrical contact therewith.

3. A discharge tube according to claim 1,
wherein the contact element (70) is connected to the outer electrode (60) in a material-locking way.

4. A discharge tube according to claim 3,
wherein the outer electrode at a radial distance from the insulator tube, forms a guiding element in which the contact element (70) is received.

5. A discharge tube according to claim 1,
wherein the guiding element is provided in the form of a channel and the contact element in the form of a wire, wherein the contact element is inserted into the guiding element.

6-18. (canceled)

19. A discharge tube according to claim 1, wherein the inner electrode is produced from a flexible laminar material, and there is provided a spring element with at least one metal wire which, along at least part of the length of the inner electrode, is in contact therewith and loads same against the inner face.

20. A discharge tube according to claim 19, wherein the spring element is provided in the form of a helical spring, wherein the outer diameter of the helical spring, in the untensioned, non-mounted condition is greater than the inner diameter of the inner electrode mounted in the insulator tube.

21. A discharge tube according to claim 1, wherein the outer electrode is produced from a radially expandable woven wire fabric or braided wire fabric in the shape of a hose.

22. A discharge tube according to claim 1, wherein the insulator tube is produced from glass, more particularly from lime soda glass or borosilicate glass.

23. A discharge tube according to claim 1, wherein that the insulator tube, at a first longitudinal end, comprises a base which is produced so as to be integral with the insulator tube, and that the insulator tube, at a second longitudinal end comprises an aperture.

24. A discharge tube according to claim 23, wherein the insulator tube, along part of its length, is designed so as to be tapered towards the aperture.
